(19) United States
(12) Patent Application Publication
(10) Pub. No.: US 2005/0201005 A1
(43) Pub. Date: Sep. 15, 2005

(54) Magnetic tape recording and reproducing apparatus

(75) Inventor: Hiroyuki Imadate, Takefu-shi (JP)

Correspondence Address: REED SMITH LLP, Suite 1400, 3110 Fairview Park Drive, Falls Church, VA, 22042, US

(73) Assignee: Orion Electric Company Ltd.

(21) Appl. No.: 11/028,528

(22) Filed: Jan. 5, 2005

(30) Foreign Application Priority Data
Mar. 12, 2004 (JP) 2004-001231 U

(51) Int. Cl. G11B 5/027

(52) U.S. Cl. 360/85

(57) ABSTRACT

The present invention is intended to provide a magnetic tape recording and reproducing apparatus such as a video recording and reproducing apparatus that does not require any additional dedicated member, and any specific and complicated steps of attaching a member to a chassis and forming a cable in a manufacturing process, and that can prevent an influence of a noise emitted from a drum motor cable to an audio head cable. This invention provides a magnetic tape recording and reproducing apparatus including: a metallic housing; a metallic chassis; and a main printed board provided on a rear surface of the chassis. A drum motor, an audio head, and a capstan motor are arranged at a first position, a second position, and a third position on a front surface of the chassis, respectively. A loading motor is arranged on one side surface of the chassis. An integrated circuit provided as a one-chip integrated circuit so as to drive the drum motor, the capstan motor, and the loading motor is arranged to be proximate to a position opposed to the capstan motor across the chassis. A drum motor cable is provided to connect the drum motor to the integrated circuit. The drum motor cable is a flat cable, and includes a portion in contact with an inner wall of the housing by a predetermined length.

### BACKGROUND OF THE INVENTION

1. Field of the Invention

The present invention relates to a magnetic tape recording and reproducing apparatus. More specifically, the present invention relates to a structure of reducing emission of a noise from a drum motor cable to an audio head cable without providing a shield plate between the drum motor cable and the audio head cable.

2. Description of the Related Art

In a magnetic tape recording and reproducing apparatus such as a video recording and reproducing apparatus, a driving integrated circuit (IC) that drives a drum motor, a capstan motor, and a loading motor has been conventionally provided as a one-chip IC to meet a demand for miniaturization of product size and manufacturing cost reduction by reducing the number of components. In this tendency, a design concept of mounting the driving one-chip IC on a capstan motor side is mainly adopted. This is based on the situation in which, since among the drum motor, the capstan motor and the loading motor, only the capstan motor changes its rotation direction in both ways of forward and backward and the other two of the drum motor and the loading motor do not change their rotation direction, and a variable range of the number of revolutions of the capstan motor is quite wide, it is necessary to control the capstan motor more strictly than the other motors.

The video recording and reproducing apparatus based on this design concept has, however, the following disadvantage. As shown in FIG. 1, a noise is emitted from a drum motor cable 7 that connects a driving IC, not shown, arranged at a position opposed to a capstan motor 5 on a rear surface of a chassis 2 to a drum motor 3. The noise enters an audio head cable 8 that connects an audio head 4 to a main printed board, not shown, and the noise is output as a noise sound from an audio output.

To solve this disadvantage, there is conventionally known a method of preventing a noise by shielding the entire audio head cable 8. In addition, as shown in FIG. 2, there is conventionally known a method of preventing an influence of the noise emitted from the drum motor cable 7 by attaching a shield plate 9 to the chassis 2 so as to cover the audio head cable 8 in a region in which the drum motor cable 7 and the audio head cable 8 are arranged to be proximate to each other and in which the audio head cable 8 tends to be influenced by the noise.

Furthermore, Patent Literature 1 discloses a method of preventing a noise emitted from a cable by forming a gap portion by partitioning a part of a housing using a divider, arranging a cable that connects a plurality of boards in the housing in the gap portion, and closely attaching the cable to a side surface of the housing.

Patent Literature 1: Japanese Patent Application Laid-Open No. 11-298168

With each of these conventional methods, however, it is disadvantageously necessary to provide the covering member for covering the cable, the shield plate for shielding the audio head cable, or the divider for partitioning a part of the housing as an additional part. In addition, it is disadvantageously necessary to provide the shield plate on the front surface of the chassis, or form the gap portion partitioned by the divider in a part of the housing and arrange the cable in the gap portion. Due to this, an assembly step is disadvantageously complicated. Further, although the method disclosed in the Patent Literature 1 can advantageously prevent the noise emitted from the cable, a cable arrangement method is stipulated in detail according a predetermined rule. As a result, an assembly operation during formation of the cable is disadvantageously and unavoidably complicated.

### SUMMARY OF THE INVENTION

The present invention has been achieved to solve the conventional disadvantages. It is an object of the present invention to provide a magnetic tape recording and reproducing apparatus such as a video recording and reproducing apparatus. According to the present invention, there is provided a magnetic tape recording and reproducing apparatus comprising: a metallic housing; a metallic chassis; and a main printed board provided on a rear surface of the chassis, wherein a drum motor, an audio head, and a capstan motor are arranged at a first position, a second position, and a third position on a front surface of the chassis, respectively, a loading motor is arranged on one side surface of the chassis, an integrated circuit provided as a one-chip integrated circuit so as to drive the drum motor, the capstan motor, and the loading motor is arranged to be proximate to a position opposed to the capstan motor across the chassis, a drum motor cable is provided to connect the drum motor to the integrated circuit, and the drum motor cable is a flat cable, and includes a portion in contact with an inner wall of the housing by a predetermined length.

The present invention can provide the magnetic tape recording and reproducing apparatus such as the video recording and reproducing apparatus that does not require any additional dedicated member, and any specific and complicated steps of attaching a member to a chassis and forming a cable in a manufacturing process, and that can prevent the influence of the noise emitted from the drum motor cable to the audio head cable.

### BRIEF DESCRIPTION OF THE DRAWINGS

FIG. 1 is a perspective view that schematically depicts a video recording and reproducing apparatus;

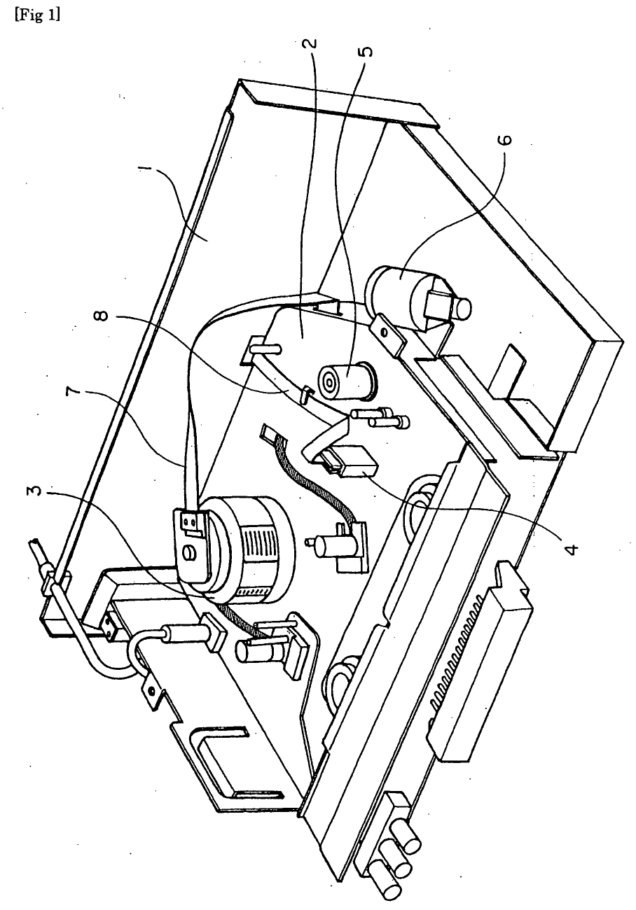

FIG. 2 is a perspective view for explaining a conventional noise preventing method using a shield plate; and

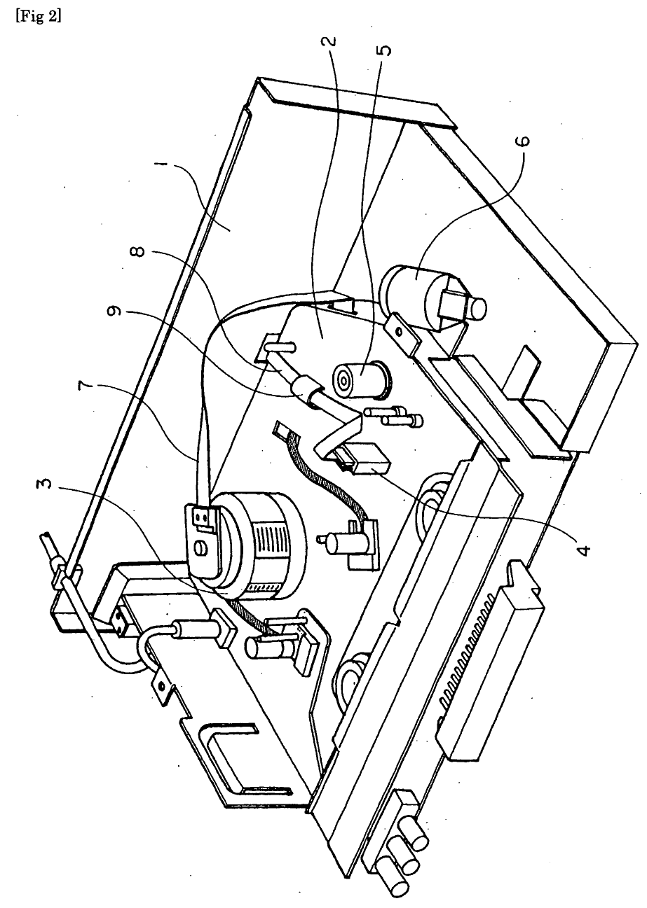

FIG. 3 is a perspective view that depicts a video recording and reproducing apparatus according to an embodiment of the present invention.

### DESCRIPTION OF THE PREFERRED EMBODIMENT

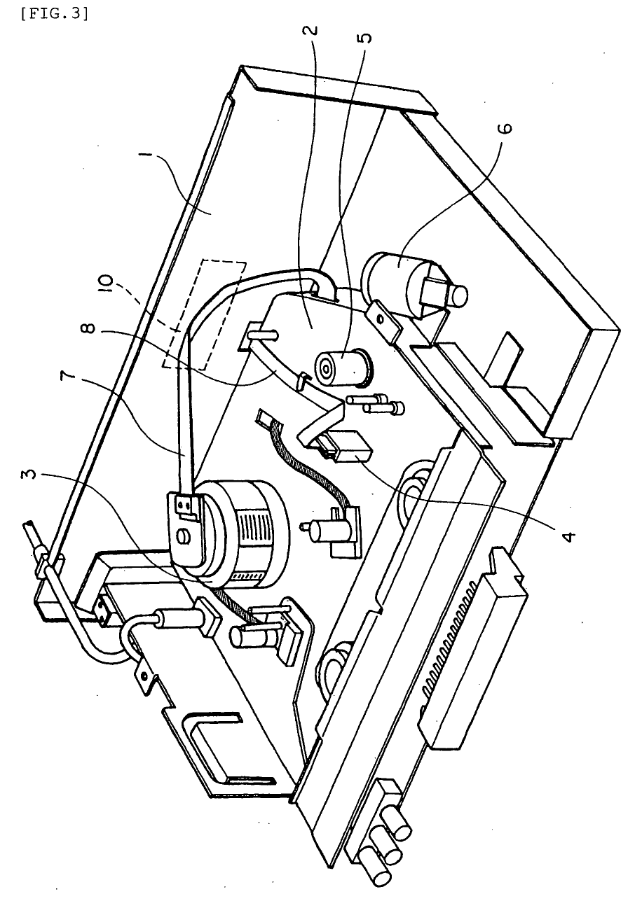

An embodiment of the present invention will be described hereinafter with reference to FIG. 3. FIG. 3 is a perspective view of a video recording and reproducing apparatus according to the embodiment of the present invention.

The video recording and reproducing apparatus shown in FIG. 3 includes a metallic housing 1, a metallic chassis 2, and a main printed board, not shown, provided on a rear surface of the metallic chassis 2. In addition, as shown in FIG. 3, a drum motor 3, an audio head 4, and a capstan motor 5 are arranged at predetermined positions on a front surface of the chassis 2, respectively. Further, a loading motor 6 is arranged on one side surface of the chassis 2. A one-chip driving IC, not shown, that drives the drum motor 3, the capstan motor 5, and the loading motor 6 is arranged in a region proximate to a position opposed to the capstan motor 5 across the chassis 2 on the rear surface of the chassis 2. A drum motor cable 7 that connects the drum motor 3 to the driving IC, and an audio head cable 8 that connects the audio head 4 to the main printed board are arranged as shown in FIG. 3.

The drum motor cable 7 and the audio head cable 8 are connected to the driving IC and the main printed board, not shown, on the rear surface of the chassis 2, respectively while crossing each other in a space above the front surface of the chassis 2 as shown in FIG. 3.

The drum motor cable 7 comes in contact with a predetermined region 10 of the metallic housing 1 by a length of at least 1 cm. It is important to set the predetermined region 10 of the metallic housing 1 at a region in which the drum motor cable 7 and the audio head cable 8 are arranged in proximity so as to cross each other in the space above the front surface of the chassis 2, and in which a noise emitted from the drum motor cable 7 influences the audio head cable 8.

As stated above, the drum motor cable 7 needs the predetermined length of at least 1 cm by which the drum motor cable 7 can come in contact with the predetermined region 10 of the metallic housing 1. In a step of arranging the drum motor cable 7, since the drum motor cable 7 is a flat cable having a certain toughness, the drum motor cable 7 can be easily brought into contact with the predetermined region 10 of the metallic housing 1 thanks to the toughness as long as the predetermined length can be secured. Besides, the drum motor cable 7 is not detached from the metallic housing 1 even by a physical impact such as a vibration or a falling after arranging the drum motor cable 7. Further, no special operation and tool for bringing the drum motor cable 7 into contact with the predetermined region 10 of the metallic housing 1 is required.

As stated in the embodiment, by bringing the drum motor cable 7 into contact with the metallic housing 1 by the length of at least 1 cm, the magnetic tape recording and reproducing apparatus capable of preventing the influence of the noise emitted from the drum motor cable to the audio head cable without need of any additional dedicated member and any special and complicated steps attaching the member to the chassis and arranging the cable in the manufacturing process can be provided.

1. A magnetic tape recording and reproducing apparatus comprising:
a metallic housing;
a metallic chassis; and
a main printed board provided on a rear surface of the chassis, wherein
a drum motor, an audio head, and a capstan motor are arranged at a first position, a second position, and a third position on a front surface of the chassis, respectively,
a loading motor is arranged on one side surface of the chassis,
an integrated circuit provided as a one-chip integrated circuit so as to drive the drum motor, the capstan motor, and the loading motor is arranged to be proximate to a position opposed to the capstan motor across the chassis on the rear surface of the chassis,
a drum motor cable is provided to connect the drum motor to the integrated circuit, and
the drum motor cable is a flat cable, and includes a portion in contact with an inner wall of the housing by a predetermined length.
